(19) United States
(12) Patent Application Publication
(10) Pub. No.: US 2017/0248510 A1
(43) Pub. Date: Aug. 31, 2017

(54) DEVICES AND METHODS FOR CHARACTERIZING PARTICLES DISPERSED IN A LIQUID MEDIUM

(71) Applicant: CORDOUAN TECHNOLOGIES, Pessac (FR)

(72) Inventors: Boris Pedrono, Leognan (FR); David Jacob, Talence (FR)

(73) Assignee: CORDOUAN TECHNOLOGIES, Pessac (FR)

(21) Appl. No.: 15/444,768

(22) Filed: Feb. 28, 2017

(30) Foreign Application Priority Data
Feb. 29, 2016 (FR) 1651675

(51) Int. Cl. G01N 15/14; G01N 21/49

(52) U.S. Cl. CPC G01N 15/1436; G01N 15/1404; G01N 21/49; G01N 2015/0038

(57) ABSTRACT

A device for characterizing particles dispersed in a liquid medium includes a fibered light emission source, a fibered optical detector, and a measurement probe intended to be hermetically submerged in the liquid medium. The measurement probe includes: a confinement tube intended to pass through at least one wall of the probe in a sealed manner and suitable for receiving a sample of the liquid medium, as well as an optical measurement head including a focusing optics for the focusing of an illumination light beam in the confinement tube and a collection optics for the collection toward the optical detector of a beam of light backscattered by the dispersed particles. The characterization device also includes a processing unit suitable for the characterization of the particles based on the backscattered-light beam.

### BACKGROUND

Technical field

The present description relates to devices for characterizing particles dispersed in a liquid medium and to characterization methods using such devices. The characterization methods apply, in particular, to monitoring the wet synthesis of nanoparticles.

Related Art

Nanoparticles are used in numerous industries such as the pharmaceutical industry, the cosmetic industry, the materials industry, the electronics industry, etc.

In particular, it is known to produce nanoparticles by wet synthesis, in a reactor, with stirring. The synthesis methods can comprise, for example, formulation and emulsification, nucleation, growth and assembly of nano-objects, nanoemulsion polymerization or encapsulation. The reactor is generally a hermetically closed vessel, which can he opaque, made of stainless steel, for example, or transparent, having generally an interior volume of more than 100 mL. The reactor is generally provided with a stirrer and with measurement probes, for example, for measuring the temperature, the viscosity, the pH or the conductivity. Mechanical and continuous stirring of the reaction medium can be ensured, for example, by means of the stirrer, at a controlled temperature. On the other hand, the reactor can also be used for the degradation of materials under the influence of an environmental parameter (temperature, pressure, lighting, presence of an enzyme, etc.) or for species separation. During the reaction, the parameters, such as viscosity, turbidity, defined as the optical transparence of the reaction medium, or the concentration of the particles, are varied.

To optimize the monitoring of the reaction, one seeks to control certain parameters of the nanoparticles, such as their size, for example, during the reaction.

Among the techniques for characterizing nanoparticles, or more generally particles of micrometric size or smaller, dynamic light scattering (or DLS) is known, for example, for the characterization of size. Inelastic scattering, for example of Raman type, or fluorescence, are also known techniques, Raman scattering and fluorescence being suitable for the analysis of the molecular composition and of the external structure. These techniques based on light scattering require the collection, during the reaction or at the end of the reaction, of a sample of the reaction medium. The sample is often a representative volume of the liquid medium, collected, for example, by means of a pipette, a peristaltic pump, a tap/valve assembly or any other device independent of the reactor. The sample thus collected is conveyed to an analysis instrument, outside of the reactor, in order to be characterized therein.

However, the collection of the sample and its conveyance to the analysis instrument results in a lost volume, since the sample collected is a lost volume. In addition, the collection and the conveying of the sample make the characterization operation delicate and empirical, since not only can the reaction conditions be disrupted by the sample collection but, in addition, there is always a difference between the characteristics of the particles during the analysis and the characteristics of the particles in the reactor, since the particles in the reactor continue to evolve throughout the sample collection and analysis period. Moreover, repeated sample collections lead to significant losses of reaction medium.

To overcome these difficulties, methods have been proposed that allow the direct characterization of the particles in a liquid medium in the reactor. Thus, the applicant has developed a probe for analysis by dynamic light scattering also referred to as DLS probe (VASCO FLEX comprising a fibered light source, also referred to as a pigtailed light source, as well as a fibered optical detector and enabling the characterization of the size of particles dispersed in a liquid medium, through a transparent wall of the reactor. The light source, for example a fiber remote laser source, sends a light beam toward the solution to be analyzed. The optical detector enables the detection at a given angle of the light that is backscattered by the particles in solution. The processing of the backscattered light enables the measurement of the size of the particles.

However, with such a DLS probe, the measurement can be disrupted by the movements of the solvent in the reactor due to the stirring of the solution applied during the reaction, resulting in an additional Doppler contribution to the movement of the particles to be qualified by the dynamic light scattering analysis.

One possibility for avoiding these measurement artifacts in media in motion could be to compensate for the additional Doppler contribution, for example, by using several DLS probes. However, these methods would be complex to carry out and costly since several DLS probes are used.

In the article by M. de Kanter et al. (“Enabling the measurement of particle sizes in stirred colloidal suspensions by embedding dynamic light scattering into an automated probe head,” Measurement 80 (2016), 92-98), a device is proposed for characterizing the size of suspended particles by means of a probe intended to be submerged in the liquid medium and making it possible to avoid movement of the solvent. This device comprises a measurement probe comprising a compartment for isolating a liquid sample and a DLS optical head for the characterization of the size of the particles of the sample isolated in the compartment. More precisely, the compartment is formed by a star with three branches which is driven by a step motor, which makes it possible, between each measurement, to introduce a liquid sample into the interior of the compartment or to remove it to the outside of the compartment.

In comparison to the above-cited methods which would use several DLS probes, the device of M. de Kanter et al., offers the advantage of greater simplicity with a single DLS optical head. However, the device described requires the presence of a motor in the probe to be submerged in the liquid medium, which results in a relatively large space requirement of the probe and sealing constraints for protecting the motor. Moreover, the DLS optical head is in direct contact with the liquid sample, which requires a cleaning of the DLS optical head between two applications and risks resulting in: contamination of the DLS optical head during the reaction.

An aim of the present description consists in proposing devices for characterizing particles dispersed in a liquid medium enabling a reliable characterization of the particles directly in the reaction medium and, in particular, of their size, by avoiding the disadvantages identified in the prior art.

### SUMMARY

According to a first aspect, the present description relates to devices for characterizing, by light scattering analysis, particles dispersed in a liquid medium. Such device comprises a fibered light emission source, a fibered optical detector, and a measurement probe intended to be hermetically submerged in the liquid medium. The measurement probe comprises a confinement tube intended to be arranged in the interior of said measurement probe and to pass in a sealed manner through at least one wall of the probe in order to receive, through an end, a sample of the liquid medium; and an optical measurement head intended to be arranged in the interior of said measurement probe, comprising a focusing optics for focusing an illumination light beam originating from the light emission source in the confinement tube, and a collection optics for the collection towards the optical detector of a beam of light backscattered by the particles dispersed in the confinement tube. The characterization device according to the first aspect further comprises a processing unit suitable for the characterization of the particles based on the backseattered-light beam measured by the optical detector.

In the present description, the term “particles” comprises objects of micrometric or sub-micrometric size. Among the particles, nanoparticles are defined as nano-objects of which half (50%), taken from a group of 100 nano-objects, have at least one dimension smaller than 100 nm. The particles and nanoparticles can comprise metal oxides, polymers, nano-objects functionalized by active molecules, crystals, molecular assemblies, biological viruses, biological macromolecules (e.g., proteins), quantum dots, nanodrops (for example, oil in water or water in oil), etc. The particles and nanoparticles dispersed in a liquid medium can form colloidal suspensions when the dispersion is stable.

All the devices and methods for characterization described in the present application apply to the characterization of particles as well as of nanoparticles.

Moreover, different physical mechanisms can be involved to generate the beam of backscattered light; for example, quasi elastic light scattering, inelastic light scattering, fluorescence, etc., each of these mechanisms making it possible to characterize different properties of the particles.

More precisely, quasi elastic light scattering results from the scattering of the illumination beam by the particles moving in the medium of the liquid, with a negligible change in wavelength. In particular, it enables the characterization of the size of the particles. It is measured by a technique referred to as DLS [acronym of the English expression “dynamic light scattering”] or photon correlation spectroscopy (PCS) , or by QELS (acronym of the English expression “quasi elastic light scattering”) or by intensity variation spectroscopy. DLS comprises the determination of variations in intensity over time of the beam of backscattered light at the wavelength of the illumination beam, in a given direction, for example, in a direction that is not co-linear with the direction of the illumination beam,

Inelastic light scattering results from scattering the illumination beam by the particles, with change in wavelength. It results from the Raman effect, for example. In particular, it enables the characterization of the particles by their molecular composition and their external structure (conformation). It is measured by the determination of the intensity of the beam of backscattered light at at least one wavelength of the useful optical spectrum that is different from the excitation wavelength.

In comparison to the characterization devices known from the prior art, the device according to the present description not only enables a characterization of the particles in motion in a medium, due to the confinement of the sample to he analyzed apart from the rest of the liquid medium, but it also makes it possible to preserve a perfect seal between the liquid medium to be analyzed and the optical probe head.

The confinement tube is transparent, at least at the wavelength of the illumination beam and at the wavelength of the backscattered light that one wishes to detect. According to one or more embodiment examples, it consists of a tube made of transparent material for visible light, for example a tube made of glass, quartz or a low-scatter plastic.

The confinement tube is, for example, a cylindrical tube having a cross section of any shape (round, polygonal, etc.). The confinement tube can also have a variable cross section. It can be straight or of any shape (curved, with straight sections and one or more angles, etc.).

The confinement tube comprises at least one open end through which the liquid sample is to he introduced when the confinement tube is mounted so that it passes through a wall of the probe.

According to one or more embodiment examples, the confinement tube is interchangeable, enabling a direct replacement of the tube between two uses of the characterization device with different liquid media, preventing sample cross contamination.

According to one or more embodiment examples, the confinement tube has a standard shape and size to facilitate its interchangeability; for example, the confinement tube is cylindrical, with a round cross section.

According to one or more embodiment examples, the volume of the confinement tube is less than 500 μL, advantageously less than 300 μL, advantageously less than 100 μL. The sample volume needed for the analysis is in fact small, typically less than 300 μL, or even less than 100 μL. A sampling tube of small volume limits the space requirement of the measurement probe.

For example, a cylindrical sampling tube having an inner diameter of less than 2 mm, ara outer diameter of less than 3 mm, and a height of less than 30 mm makes it possible to form a total volume of less than 375 μL for a useful sample volume of less than 250 μL.

According to one or more embodiment examples, the measurement probe has a substantially cylindrical outer envelope having a diameter less than or equal to 1″ (2.54 cm) and a length of 10 cm to 20 cm, for example, the length depending on the size of the reactor.

According to one or more embodiment examples, the measurement probe has a substantially cylindrical outer envelope having a diameter of less than 12 mm.

According to one or more embodiment examples, the characterization device further comprises a controlled suctioning device, suitable for suctioning the sample of liquid medium into the confinement tube and removing the sample of liquid medium from the confinement tube. The controlled suctioning device enables the introduction and the removal of the liquid sample, in particular when the confinement tube is to pass through a wall of the measurement probe through only one of its ends.

According to one or more embodiment examples, the suctioning device is a vacuum suction device, which can be installed outside of the measurement probe, at a distance from the confinement tube, making it possible to limit the space requirement of the measurement probe. For example, the controlled suctioning device comprises a syringe, a vacuum pump, a peristaltic pump, a suction bulb.

According to one or more embodiment examples, the confinement tube is intended to pass substantially vertically through a lower wall of the measurement probe, facilitating its insertion in a sealed manner through the wall of the measurement probe. Although any shape can be used for the tube, according to one or more embodiment examples the confinement tube is straight, which facilitates its interchangeability.

According to one or more embodiment examples, and, in particular, when the confinement tube comprises at least one substantially vertical section, the optical measurement head comprises an element for deflecting the illumination beam toward the confinement tube and the backscattered-light beam toward the collection optics.

According to one or more embodiment examples, the deflection element comprises a beam splitter, a mirror or a total reflection glass prism.

According to one or more embodiment examples, the deflection element comprises a selective wavelength splitter (for example, a dichroic filter) for the separation of the illumination beam and the backscattered beam in the case of the analysis of light scattering with change of wavelength (fluorescence or inelastic light scattering).

According to one or more embodiment examples, the deflection element is movable, enabling the adjustment of the focusing distance of the illumination beam in the confinement tube.

According to one or more embodiment examples, the confinement tube is intended to pass through a lateral wall of the measurement probe in a sealed manner through its two ends. In particular, this embodiment example makes it possible to avoid using a suctioning device by using the flow present in the liquid medium for filling the confinement tube.

In this example, although the confinement tube can be of any shape and have any orientation in the interior of the measurement probe, it can be straight so as to facilitate its interchangeability. Moreover, its inclination can be adapted in order to facilitate its filling.

According to one or more embodiment examples, the confinement tube is intended to be mounted substantially horizontally in the interior of the measurement probe.

According to one or more embodiment examples, the focusing optics and the collection optics comprise a variable-focus lens enabling the adjustment of the focusing distance of the illumination and collection beams in the confinement tube.

According to one or more embodiment examples, the focusing optics and the collection optics are formed by only one and the same lens suitable for transmitting the illumination beam and the backscattered-light beam.

According to one or more embodiment examples, when the illumination and backscattered-light beams are intended, during operation, to propagate in non co-linear directions, said beams can pass through the common focusing and collection optics at two different sites of the optics, for example, one of the beams can pass through the optics along its axis.

According to one or more embodiment examples, the focusing and collection optics comprise a variable-focus lens enabling the adjustment of the focusing distance of the illumination beam in the confinement tube.

According to a second aspect, the present description relates to a method for characterizing particles dispersed in a liquid medium using a characterization device according to the first aspect.

According to one or more embodiment examples, the characterization method comprises the following steps:

(a1) immersion of the measurement probe in the liquid medium;

(a2) introduction of a sample of the liquid medium into the interior of the confinement tube;

(a3) focusing of an illumination beam emitted by the light emission source in the sample;

(a4) detection of a backscattered light beam by means of the optical detector and characterization of the particles; and

(a5) release of the sample into the liquid medium.

According to one or more embodiment examples, the sample volume introduced is less than 300 μL, advantageously less than 100 μL.

According to one or more embodiment examples, step (a4) of detection of backscattered-light beam and of characterization of the particles comprises a dynamic light scattering (DLS) analysis for the characterization of the size of the particles.

According to one or more embodiment examples, step (a4) of detection of the beam of backscattered light and of characterization of the particles comprises a static light backscattering analysis at a wavelength different from the wavelength of the illumination beam; this type of analysis makes possible, for example, the characterization of the molecular composition and/or of the external structure of the particles by means of the analysis of Raman scattering or of fluorescence.

According to one or more embodiment examples, operation (a2) of introduction of the sample of the liquid medium comprises the controlled suctioning of the liquid medium into the confinement tube by means of a suctioning device.

According to one or more embodiment examples, when the confinement tube passes in a sealed manner through a lateral wall of the measurement probe through its two ends, the operation (a2) of introduction of the sample of the liquid medium comprises:
the rotation of the measurement probe into a first position so that the confinement tube is in a direction substantially parallel to a flow in the liquid medium, enabling the filling of the confinement tube;
once the confinement tube has been filled, the rotation of the measurement probe into a second position so that the confinement tube is in a direction substantially perpendicular to the flow in the liquid medium.

According to one or more embodiment examples, the characterization method further comprises the adaptation of the focusing distance of the illumination beam in the sample as a function of the concentration and/or of the absorption of the particles of the liquid medium.

According to one or more embodiment examples, the characterization method according to the present description is applied to monitoring the synthesis of nanoparticles. It can comprise the repetition of operations (a2) to (a5) during the synthesis of the nanoparticles.

### BRIEF DESCRIPTION OF THE DRAWINGS

Other advantages and features of the one or more embodiments of the invention will become apparent upon reading the description, illustrated by the following figures:

FIG. 1 represents a general diagrammatic view of an example of a device for characterizing particles dispersed in a liquid medium, according to the present description;

FIGS. 2A, 2B and 2C represent diagrammatic views of an example of a measurement probe of a characterization device according to the present description, during different phases of a method for characterizing particles dispersed in a liquid medium, according to the present description;

FIGS. 3A, 3B and 3C represent diagrammatic views of embodiment examples of a measurement probe of a characterization device according to the present description;

FIGS. 4A, 4B, 4C and 4D represent diagrammatic side and top views of another example of a measurement probe of a characterization device according to the present description, during different phases of a characterization method according to the present description;

FIGS. 5A, 5B and 5C represent diagrammatic views of other embodiment examples of a measurement probe of a characterization device according to the present description.

### DETAILED DESCRIPTION

In the figures, identical elements are marked by identical references. For reasons pertaining to the readability of the figures, the size scales between elements represented are not observed.

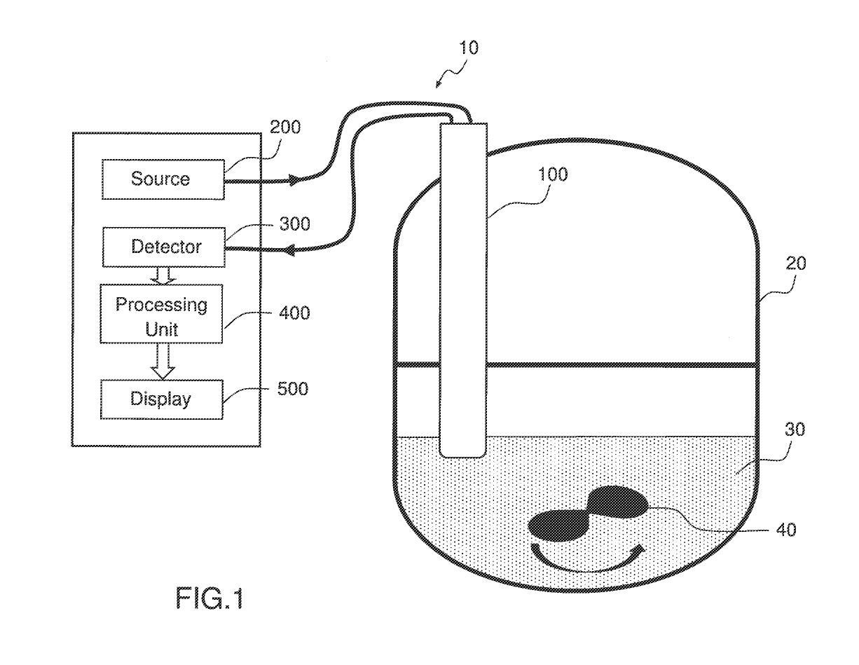

FIG. 1. diagrammatically represents a reactor 20 containing a liquid medium 30 in which the characterization device 10 according to the present description is partially submerged. The liquid medium 30 contained in the reactor 20 contains particles dispersed in the liquid medium, for example, suspended particles, and can be maintained, for certain applications, under stirring with a stirrer 40. The stirrer 40 can be of mechanical or magnetic type; it can be driven by a mechanical shaft or by a magnetic device arranged outside of said reactor, and ensure continuous or intermittent stirring of the liquid medium.

The characterization device 10 comprises a measurement probe 100 suitable for being at least partially submerged in the liquid medium 30, as well as a light emission source 200 and an optical detector 300.

The light emission source 200, hereafter referred to as the light source, can be, for example, a laser source at a given wavelength. The light source 200 is capable of emitting an illumination beam, for example, a laser beam, which is transmitted by optical fiber into the measurement probe 100 in order to illuminate a sample of the liquid medium. The light source 200 is referred to as “fibered.”

The optical detector 300, hereafter referred to simply as detector, is capable of detecting a beam of light backscattered by a sample of the liquid medium; the beam of backscattered light or “backscattered beam” is collected by the measurement probe 100 and transmitted by optical fiber from the measurement probe 100 to a detector 300 which is referred to as “fibered.” The detector 300 can be, for example, a photon counting optical detector, of the photomultiplier or avalanche photodiode type.

The optical fibers optically connecting, on the one hand, the light source 200 and the measurement probe 100, and, on the other hand, the detector 300 and said measurement probe 100 can include, for example, single-mode or multi-mode fibers, or packets of single-mode or multi-mode fibers, for example, polarization maintaining fibers.

The detector 300 is electrically connected to a processing unit 400 which performs the characterization of the particles present in a sample of the liquid medium based on the beam of backscattered light detected by the detector 300.

For example, in the case of dynamic light scattering (DLS) analysis, the processing unit analyzes the variations in the intensity of the beam of backscattered light over time in order to derive size distributions therefrom. The processing unit can comprise, for example, a correlation subunit and a calculation subunit for calculating the size of the particles. In some examples, the correlation subunit can be implemented by a specific correlator.

In the case of static light scattering analysis, for example, by inelastic light scattering, the processing unit can determine the molecular composition and the external structure of the particles from the optical spectrum of the backscattered-light beam or from the intensity of the beam of scattered light at at least one wavelength of the spectrum

The characteristics of the particles obtained by characterization of, for example, their size, can then be displayed on a display 500 connected to the processing unit 400.

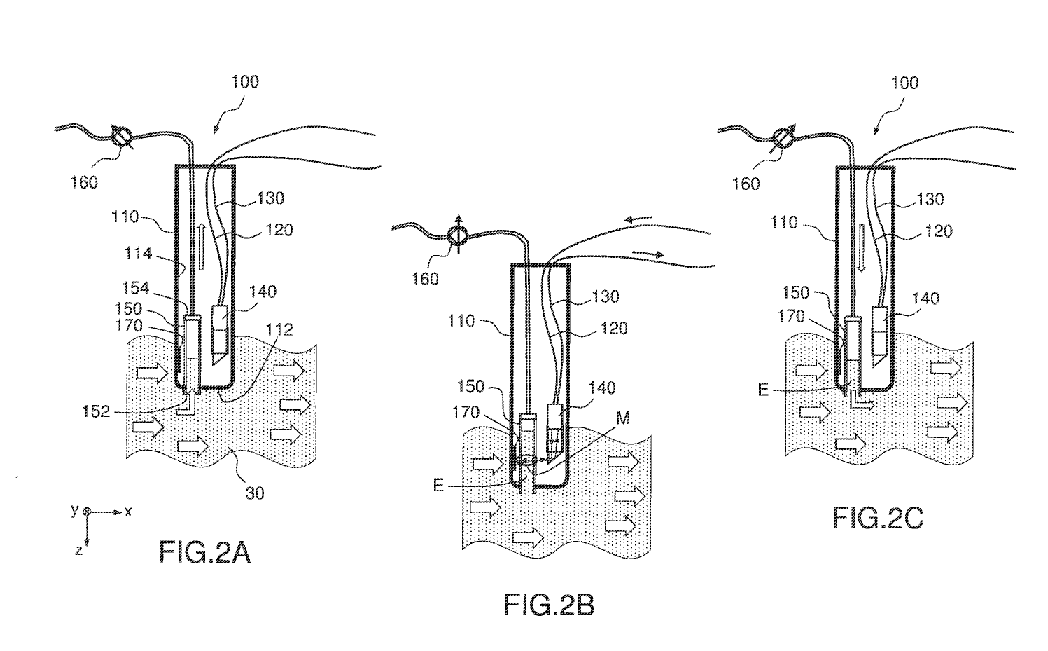

A measurement probe example 100 is represented diagrammatically in FIGS. 2A, 2B and 2C. In this example, the measurement probe 100 comprises a sealed enclosure 110, which is advantageously chemically inert, in the interior of which a confinement tube 150 and an optical measurement head 140 are mounted. The enclosure 110 of the measurement probe 100 is dosed, in this example. The optical measurement head 140 is connected to the light source 200 and to the detector 300, respectively, by optical fibers 120 and 130.

The confinement tube 150 is suitable for receiving a sample Ii of the liquid medium 30. The confinement tube 150 is for example cylindrical, having any cross section, for example round or polygonal. The cross section of the confinement tube has a transverse dimension of preferably between 0.1 and 5 mm. The confinement tube presents an optically transparent wall, advantageously chemically inert, made of glass for example.

The confinement tube 150 comprises at least one open end, referred to as opening end, intended to pass in a sealed manner through a. wall of the measurement probe, and through which the liquid of the medium 30 can be introduced into the tube. In the case of a confinement tube having only a single opening end, the liquid is also removed through said end, In certain embodiment examples, the two ends of the confinement tube can be opening, as will be described below; in this case, the liquid of the medium 30 can be introduced into the tube through one of the ends and removed through the other end. Thus, the opening end(s) of the confinement tube lead(s) into the liquid medium 30, while the central portion of the confinement tube is hermetically enclosed in the measurement probe.

The confinement tube 150 thus forms a closed measurement chamber in which a sample of the liquid medium can be isolated from said liquid medium to be characterized therein, without being subjected to the possible stirring of the liquid medium, This sample being drawn directly from the liquid medium and maintained confined in the confinement tube, it can be analyzed, or characterized, in real time, without opening the reactor or stopping the stirring and without interruption of the reaction of the liquid medium.

Moreover, since the enclosure 110 of the measurement probe is sealed, the optical measurement head remains perfectly isolated from any liquid splashes of the liquid medium 30 or of the sample to be analyzed. Thus, the probe does not need to be cleaned between two characterizations of different liquid media.

In certain embodiment examples, the confinement tube 150 can be interchangeable, that is to say that the tube in the measurement probe is replaced for each new characterization of a new liquid medium. The interchangeability of the confinement tube allows easy maintenance and repair of the device.

According to one or more embodiment examples, the characterization device comprises an optical trap 170 represented diagrammatically by a black rectangle in FIG. 2B; the optical trap makes it possible to absorb the light transmitted by the sample in order to avoid interfering reflections that could hinder the analysis of the backscattered light.

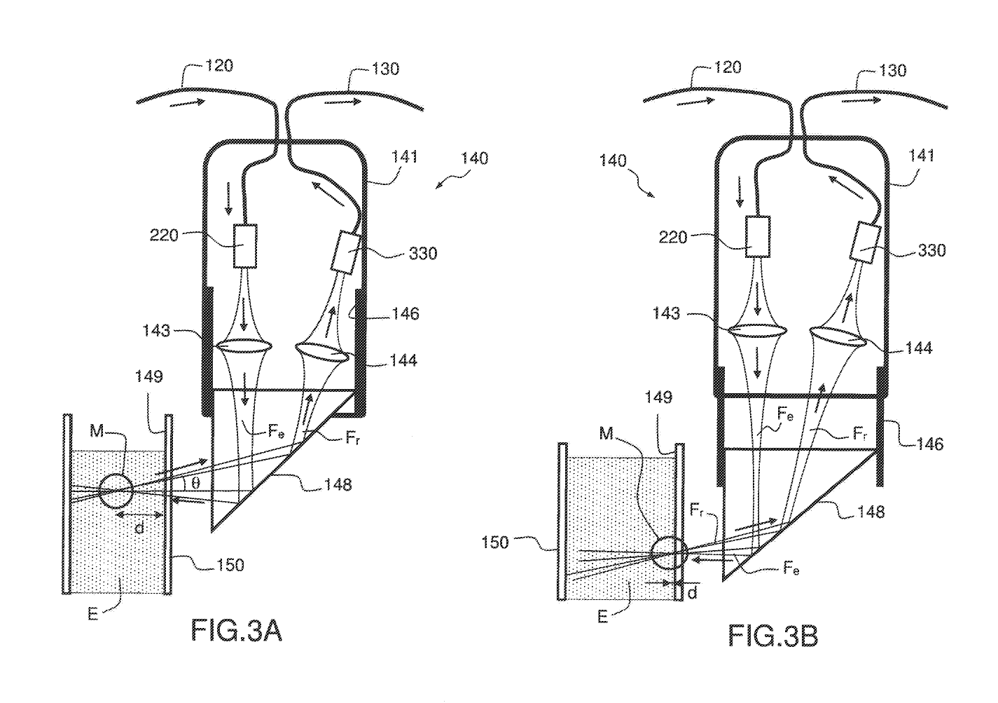

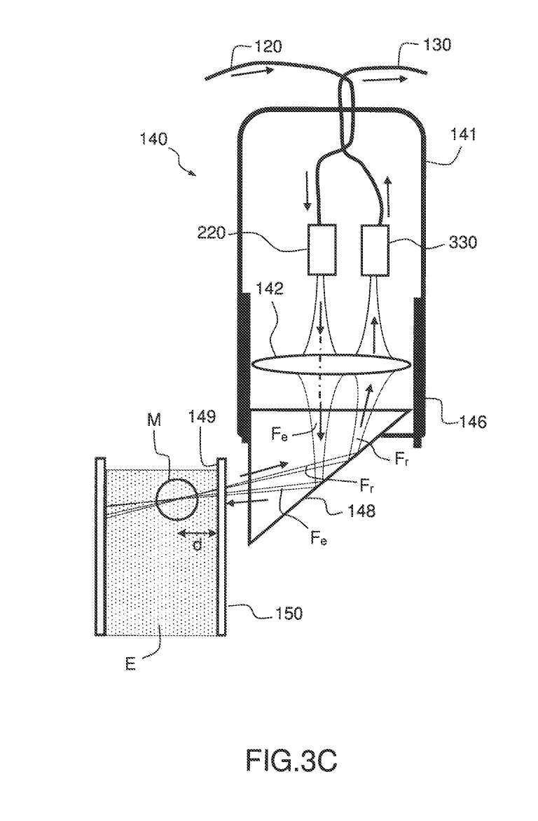

According to an embodiment illustrated in FIGS. 2A to 2C and 3A to 3C, the confinement tube has a single opening end 152 which passes through a wall of the enclosure 110 of the measurement probe. In contrast, the upper end 154 of the confinement tube 150 can be closed. The upper end 154 is connected to a suctioning device 160 enabling the suctioning of the liquid sample into the confinement tube 150 and its removal from said confinement tube, respectively. In one or more embodiment examples, the suctioning device is a vacuum suctioning device which offers the advantage of being simple and reliable and which can be installed outside of the measurement probe, at a distance from the confinement tube. The suctioning device 160 can be, for example, a vacuum pump, a syringe or any other device capable, on the one hand, of suctioning a predetermined quantity of liquid into the confinement tube, and, on the other hand, of draining the sample by removing the liquid from the tube.

FIGS. 2A to 2C illustrate, according to an example, steps of a method for characterizing particles dispersed in the liquid medium 30. The characterization of the particles is obtained by analysis of the light backscattered by the liquid sample confined in the confinement tube 150. The liquid sample to he analyzed can be obtained according to the method shown diagammatically in FIGS. 2A, 2B and 2C:
FIG. 2A: The measurement probe 100 is submerged in the reactor 20, and a liquid sample E is introduced into the confinement tube 150 from the lower end 152 of said tube, by suction generated by the suctioning device 160; the suction is controlled in such a manner that the height of the sample in the confinement tube is sufficient for the measurement zone to be located in the sample;
FIG, 2B: the sample E is confined in the confinement tube 150. The analysis of the backscattered-light beam can then be carried out in order to characterize the particles present in the sample;
FIG. 2C: once the characterization of the particles contained in the liquid sample E is completed, the liquid sample is removed from the confinement tube 150 by means of the suctioning device 160.

A new liquid sample can then be introduced into the confinement tube 150 for a new characterization. Several characterizations can thus occur successively, making it possible to provide an evolution, in real time, of the characteristics of the particles of the liquid medium. Successive characterizations can be carried out until the measured characteristics of the particles correspond to predetermined characteristics. In the case of a synthesis of nanoparticles, for example, the characterizations can occur successively until the measured size of the nanoparticles corresponds to the desired size. In the case of a separation of particles, the characterizations can occur successively until the separation of the particles is achieved,

FIGS. 3A-3C illustrate in greater detail examples of measurement probes 100 in which the confinement tube 150 has at least one substantially vertical portion. “Substantially vertical” portion is understood to mean a portion which extends in a direction more or less parallel to the axis of the enclosure 110 of the measurement probe, that is to say in a general direction Z, in the reference system (X, Y, Z) of FIG. 2A, with a deflection angle with respect to the vertical of less than ±0.5°.

The confinement tube can have, for example, elbow parts and an opening end that passes through a lateral wall of the measurement probe. According to one or more embodiment examples, the confinement tube is a straight tube, arranged substantially vertically in the measurement probe, in this example substantially parallel to the optical axis of the focusing optics, and it has an opening end 152 which passes through a lower wall 112 of the enclosure 110 of the measurement probe, as represented in FIGS. 2A to 2C. This particular arrangement makes it possible, in particular, to reduce the sampled volume quantity and it enables an optimization of the space requirement in the interior of the measurement probe, which makes it possible to reduce the external volume thereof.

The measurement probe 100 illustrated in FIGS. 3A to 3C comprises an optical measurement head 140 and a confinement tube 150 of which only a central vertical portion is represented here.

In the example of FIG. 3A, the optical measurement head 140 comprises a light emission head 220 for the emission of an illumination beam Fe, the light emission head 220 receiving the light beam emitted by the light source 200 by means of the optical fiber 120. The light emission head 220 can be formed simply by the end of the optical fibers 120 or comprise a shaping optics (not represented). The optical measurement head 140 also comprises a reception head 330 for the reception of the backscattered-light beam Fr and the transmission to the detector 300 by means of the optical fiber 130. The reception head again can comprise a shaping optics for sending the backscattered-light beam Fr to the input side of the optical fiber 130.

The optical measurement head 140 also includes a focusing optics 143 for the focusing of the illumination beam Fe in the sample E, a collection optics 144 for the collection of the beam Fr of light backscattered by the particles dispersed in the sample E, and a deflection element 148 which, in this example, makes it possible to deflect the illumination beam and the backscattered-light beam in order to illuminate the sample and collect the backscattered light, respectively, in the case in which the confinement tube is arranged so as to be substantially parallel to the optical axes of the focusing optics and/or the collection optics. The focusing optics 143 and the collection optics 144 can comprise a lens or a group of lenses. The deflection element 148 can comprise a minor, a glass slide or a deflecting prism, for example, a total reflection prism, as illustrated in the example of FIG. 3A.

As represented by the arrows in FIG. 3A, the deflection element 148 reflects the illumination beam Fe toward a measurement zone M of the confinement tube 150. At the point of focusing of the illumination beam Fe in the liquid sample F, the light received by the sample is scattered by the particles dispersed in the liquid sample, either by quasi elastic light scattering (without change of wavelength) or by inelastic light scattering, for example, by Raman effect (at a longer wavelength). The backscattered-light beam Fr is defined by the beam of light reflected by the deflection element 148 and collected by the collection optics 144. Thus, by arranging the relative positions of the illumination optics 143 and the collection optics 144 as well as their optical axes, it is possible to adjust the angle between the illumination beam and the backscattered-light beam. Thus, in the example of FIGS. 3A and 3B, the optical axes of the illumination optics 143 and of the collection optics 144 have a non-zero angle making it possible to analyze the backscattered light in a direction that is not co-linen with the direction of the illumination beam. For example, the backscattered-light beam has an angle between 90° and 175° in the case in which one seeks to measure the quasi elastic light scattering (DLS), this angle making it possible to avoid the interfering paraxial reflections and to preserve a self-beating interference mode, and avoid heterodyne beating.

According to one or more embodiment examples, the optical head can comprise a wavelength selective splitter for the separation of the illumination beam and the backscattered beam in the case of analysis of scattering with change of wavelength. For example, it is possible to use a dichroic filter arranged on the deflection element 148. It is also possible to provide a fluorescence rejecting filter, of the band-pass filter type, for removing fluorescence light when one seeks to characterized another scattering type, for example, a Raman scattering.

According to one or more embodiment examples, the deflection element 148 is movable in translation along a direction parallel to the optical axis of the focusing optics and/or the collection optics. This mobility of the deflection element 148 can be achieved, for example, by means of a sliding mechanical device 146, such as a pair of rails mounted on the wall 141 of the optical measurement head 140, and between which the deflection element 148 is attached. The mobility of the deflection element 148 enables an adjustment of the working distance d between the measurement zone M (where the illumination beam Fe is focused in the liquid sample E) and the internal surface 149 of the confinement tube. Thus, it is possible to adapt the positioning of the measurement zone M to the concentration and to the absorption of the sample, connected with the particle concentration of the liquid sample.

Thus, in an embodiment example, the working distance can be adjusted in a range from 0 to 5 mm by translation of the deflection element 148. In the case of a particle synthesis operation, for example, the working distance d can be selected to be greater, for example, at the beginning of the synthesis operation, when the liquid has a low particle concentration (FIG. 3A), and it can be selected to be shorter, for example, at the end of the synthesis operation, when the liquid medium is highly concentrated and opaque (FIG. 3B). In other words, when the solution to be analyzed is turbid, the working distance is selected to be short, that is to say the measurement zone M is selected to be close to the wall 149 of the confinement tube 150, so that the backscattered-light beam Fr is not altered by the multiple scattering due to the turbidity of the liquid present between the measurement zone M and the wall of the confinement tube and the signal detected is sufficient. These embodiment examples thus allow a great adaptability to all liquid media, whether they are diluted or partially turbid or opalescent.

The adjustment of the working distance d can also be obtained by means of variable-focus illumination optics 143 and collection optics 144.

FIG. 3C illustrates a variant of FIGS. 3A and 3B, in which the focusing optics and the collection optics are formed by a common optics 142, the other elements being unchanged. Thus, the common optics 142 ensures simultaneously the focusing of the illumination beam Fe and the collection of the backscattered-light beam Fr.

According to an embodiment example illustrated in FIG. 3C, the optical emission head 220 and the optical reception head 330 are arranged in such a manner that the illumination beam Fe and backscattered-light beam Fr are incident in an offset manner on the common optics 142, one of the two beams being incident on the optical axis of the common optics 142 for example, and the other being off-center. This configuration makes it possible to detect, with a common optics 142, a backscattered-light beam Fr that is not co-linear with the illumination beam. This configuration also makes it possible to detect co-linear illumination beam Fe and backscattered-light beam Fr using, for example, a polarimetric system of the optical isolator type, which makes it possible to separate the polarizations.

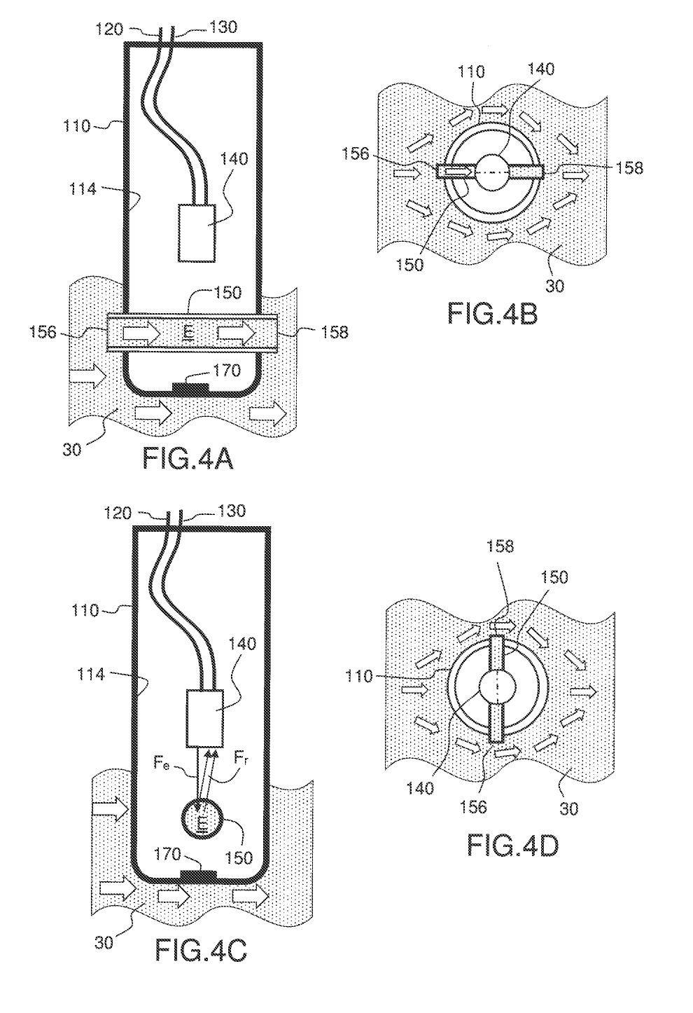

FIGS. 4A to 4D illustrate another embodiment example of a measurement probe of a characterization device according to the present description, in which the confinement tube 150 has two opening ends in the lateral wall 114 of the enclosure 110 of the measurement probe 100.

In the example illustrated in FIGS. 4A-4D, the confinement tube 150 is straight and arranged substantially horizontally in the measurement probe, that is to say it has an inclination angle with the horizontal of ±0.5°. However, it could have other shapes and/or have a non-zero inclination with the horizontal direction.

In the example illustrated in FIGS. 4A to 4D, the filling of the confinement tube 150 can be obtained by positioning the measurement probe in such a manner that the confinement tube 150 is in the direction of the liquid flow generated by the stirrer 40 and represented diagrammatically by the double arrows in FIGS. 4A-4D. This positioning of the measurement probe corresponds to a first position shown in a cross-sectional side view in FIG. 4A and shown in a cross-sectional top view in FIG. 4B. Once the liquid sample E is introduced into the confinement tube 150, the measurement probe is rotated along its axis into a second position, so that the confinement tube is not in the direction of the liquid flow generated by the stirrer. As shown in FIGS. 4C and 4D, the second position of the measurement probe can be approximately perpendicular to the first position. In this second position, the liquid sample in the interior of the confinement tube is isolated from the stirring of the liquid medium 30, since, with the opening end 156 of the tube perpendicular to the direction of the flow of the liquid, the liquid in the interior of the tube is no longer subjected to the movement of the liquid medium. When the characterization of the sample F is completed, the confined sample can be removed from the confinement tube by rotating the measurement probe again into the first position, the liquid flow of the medium 30 pushing the confined liquid out of the confinement tube. A new liquid sample can then be analyzed. This embodiment example offers the advantage of not requiring any equipment for auctioning the liquid into the confinement tube and removing it from said confinement tube.

As explained above, several characterizations can occur successively, providing an evolution, in real time, of the characteristics of the particles of the liquid medium. Therefore, for example, an operator can follow the kinetic of the reaction in the liquid medium 30 in real time, from the time of contacting of the reactants to the end of the reaction.

Naturally, in certain embodiment examples (not represented in the figures), only one end 156 of the confinement tube 150 can be open and pass through a lateral wall 114 of the enclosure 110 of the measurement probe in order to open into the liquid medium 30. In these embodiment examples, the non-opening end 158 is connected to a suctioning device enabling the suctioning of the liquid sample E into the confinement tube 150 and its removal from said confinement tube, respectively, as explained above in relation to FIG. 2A-2C.

According to one or more embodiment examples, the characterization device comprises, as in the preceding examples, an optical trap 170 represented diagrammatically by a black rectangle in FIG. 4A or 4C; the optical trap makes it possible to absorb the light transmitted by the sample in order to avoid the interfering reflections that can hinder the analysis of the backscattered light.

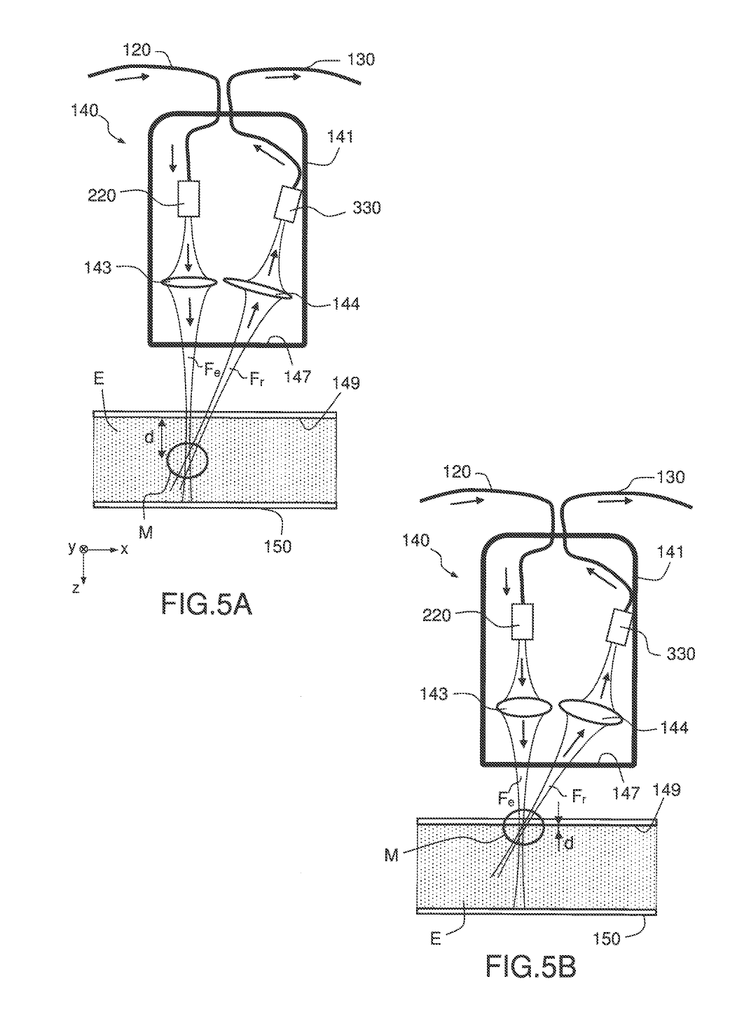

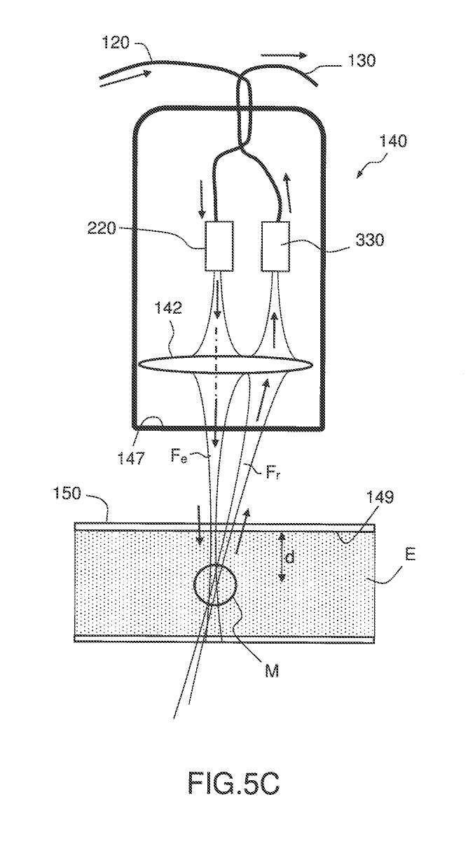

FIGS. 5A, 5B and 5C represent examples of a measurement probe 100 of a device according to the present description, in which the confinement tube includes at least one horizontal or slightly inclined (inclination less than ±20′) portion in the interior of the measurement probe. This can pertain to a horizontal straight tube, as represented in. FIG. 4A to 4D, or a confinement tube opening on a lower wall of the enclosure of the measurement probe, but which has a horizontal or slightly inclined section,

In this configuration, it is no longer necessary to provide a deflection element for the optical measurement head 140. In other words, the confinement tube 150, of which only the central portion is represented here, is located below the optical measurement head 140, that is to say opposite the focusing optics 143 and the collection optics 144.

Thus, in the example of FIGS. 5A and 5E, the elements of the optical measurement head are similar to those of FIGS. 3A and 3B, except that there is no deflection element 148.

More precisely, as represented by the arrows in FIG. 5A, the focusing system 143 focuses the illumination beam Fe toward a measurement zone M of the confinement tube 150. At the point of focusing of the illumination beam. Fe in the liquid sample E, the light received by the sample is scattered by the particles dispersed in the liquid sample, whether the scattering be quasi elastic light scattering or inelastic light scattering, for example, by the Raman effect. The backscattered light beam Fr is defined by the backscattered-light beam collected by the collection optics 144. Thus, by arranging the relative positions of the illumination optics 143 and the collection optics 144 as well as of their optical axis, it is possible to adjust the angle between the illumination beam and the backscattered-light beam. Thus, in the example of FIGS. 5A and 5B, as in the example of FIGS. 3A and 3B, the optical axes of the illumination optics 143 and the collection optics 144 have a non-zero angle enabling the analysis of the backscattered light in a direction that is not co-linear with the direction of the illumination beam.

As in the preceding example, the optical head can comprise a wavelength selective splitter for the separation of the illumination and backscattered beams in the case of analysis of the scattering with change of wavelength (not represented in the figures).

In one or more embodiment examples, one can seek to adjust the working distance between the measurement zone M (where the illumination beam Fe is focused in the liquid sample E), in particular, in order to take into account the turbidity of the solution, as explained above. For this purpose, the focusing optics 143 and the collection optics 144 can comprise variable-focus lenses, for example, electrically controlled variable-focus liquid lenses marketed by the company Varioptic© or the company Optotune©. In other embodiment examples, the adjustment of the working distance d between the measurement zone M and the lower wall 149 of the confinement tube 150 can be obtained by means of electromechanical microsystems or MEMS (abbreviation of the English expression “microelectromechanical system”) by modification of the individual deflection angles.

FIGS. 5A and 5B thus illustrate two different examples of placement of the measurement zone M. In the example of FIG. 5A, the measurement zone M is positioned approximately centrally within the confinement tube 150, at a distance d from the lower wall 149 of the confinement tube 150. In this case, the focal length of the focusing optics 143 is selected in such a manner that the point of focusing in the measurement zone M is approximately at the center of the confinement tube. On the other hand, in the example of FIG. 58, the measurement zone M is close to the internal wall 149 of the confinement tube 150. The focal length of the collection of optics 144 is adapted to the working distance d selected. The angle formed by the two beams Fe and Fr can then be recalculated by the processing unit 400.

FIG, 5C illustrates a variant of FIGS. 5A and 5B in which the focusing optics and the collection optics are formed by a common optics 142, the other elements being unchanged. Thus, as in the example of FIG. 3C, the common optics 142 ensures simultaneously the focusing of the illumination beam Fe and the collection of the backscattered-light beam Fr. In the example of FIG. 5C, the elements of the optical measurement head are thus similar to those of FIG. 3C except that there is no deflection element 148.

In particular, the optical emission head 220 and the optical reception head 330 are arranged in such a manner that the illumination beam Fe and backscattered-light beam Fr are incident in an offset manner on the common optics 142, one of the two beams being incident, for example, on the optical axis of the common optics 142 and the other being off-center. This configuration makes it possible, using a common optics 142, to detect a backscattered-light beam Fr that is not co-linear with the illumination beam.

The characterizing device which has just been described can be implemented as follows:
submersion of the measurement probe 100 in the reactor 20 containing the liquid medium 30 in which several reactants react together;
introduction and confinement of a sample E of the liquid medium 30 in the confinement tube 150, by rotation of the measurement probe or by suctioning;
emission of an illumination beam Fe and focusing of this illumination beam toward a measurement zone M of the confinement tube 150;
detection of a beam Fr of light backscattered by the particles of the liquid sample E and transmission to the processing unit 400;
processing, by the processing unit 400, of the backscattered-light beam Fr and characterization of the particles, for example, by their size and/or their composition;
release of the liquid sample E into the medium.

After the step of release of the sample E, a new sample E′ can be introduced in the confinement tube, then confined, and characterized by the steps mentioned above. A plurality of new samples can thus be characterized after one another until the desired characteristics are obtained.

Regardless of the embodiment examples, the characterization device according to the present description has the advantage of being compact and of having a small space requirement (typically a volume having a lateral dimension of less than 30 mm and a height dimension of less than 80 mm). In addition, it has the advantage of enabling the characterization of a sample in the interior of the reactor, without requiring any sample collection outside of the reactor and while preventing any contact of the optical measurement head with the liquid medium.

Moreover, the characterization of the particles by light scattering, as has just been described, can be coupled with other characterizations such as, for example, the temperature, the viscosity, the imaging, etc., using specific devices.

Although described by way of a certain number of detailed embodiment examples, the devices and methods for characterizing particles dispersed in a liquid medium according to the present description comprise different variants, modifications and improvements which will be obvious to the person skilled in the art, it being understood that these different variants, modifications and improvements are part of the scope of one or more embodiments of the invention as defined by the following claims.

What is claimed is:

1. A device for characterizing particles dispersed in a liquid medium comprising:
a fibered light emission source;
a fibered optical detector;
a measurement probe intended to be hermetically submerged in the liquid medium and comprising:
a confinement tube intended to be arranged in an interior of said measurement probe and to hermetically pass through at least one wall of the probe in order to receive, through an end, a sample of the liquid medium;
an optical measurement head intended to be arranged in the interior of said measurement probe, comprising focusing optics for focusing, in the confinement tube, an illumination light beam originating from the light emission source and a collection optics for the collection toward the optical detector of a beam of light backscattered by the particles dispersed in the confinement tube; and
a processing unit suitable for the characterization of the particles based on the backscattered-light beam measured by the optical detector.

2. The device for characterizing particles according to claim 1, wherein the confinement tube passes through a lower wall of the measurement probe, and wherein the measurement probe is substantially vertical.

3. The device for characterizing particles according to claim 2, wherein the optical measurement head comprises a deflection element for deflecting the illumination beam toward the confinement tube and the backscattered-light beam toward the collection optics.

4. The device for characterizing particles according to claim 3, wherein the deflection element is moveable, enabling an adjustment of a focusing distance of the illumination beam in the confinement tube.

5. The device for characterizing particles according to claim 1, further comprising a controlled suctioning device, suitable for suctioning the liquid medium sample into the confinement tube and removing the liquid medium sample from the confinement tube.

6. The device for characterizing particles according to claim 1, wherein the confinement tube passes through a lateral wall of the measurement probe in a sealed manner through two ends of the measurement probe.

7. The device for characterizing particles according to claim 1, wherein the focusing optics and the collection optics are formed by the same optics, suitable for receiving the illumination and backscattered-light beams.

8. The device for characterizing particles according to claim 1, wherein the backscattered-light beam and the illumination beam are intended to be non-colinear.

9. The device for characterizing particles according to claim 1, wherein the focusing optics and/or the collection optics comprise a variable-focus lens enabling an adjustment of a focusing distance of the illumination beam in the confinement tube.

10. A method for characterizing particles dispersed in a liquid medium using a device for characterizing particles according to claim 1, comprising the following steps:
(a1) immersion of the measurement probe in the liquid medium;
(a2) introduction of a sample of the liquid medium into an interior of the confinement tube;
(a3) focusing of an illumination beam emitted by the light emission source in the sample;
(a4) detection of a backscattered-light beam by means of the optical detector and characterization of the particles; and
(a5) release of the sample into the liquid medium.

11. The method for characterizing particles according to claim 10, wherein step (a4) of detection of the backscattered-light beam. and of characterization of the particles comprises a dynamic light scattering (DLS) analysis.

12. The method for characterizing particles according to claim 10, wherein step (a4) of deflection of the backscattered-light beam and of characterization of the particles comprises a static light backscattering analysis at a wavelength different from the wavelength of the illumination beam.

13. The method for characterizing particles according to claim 10, wherein the step (a2) of introduction of the sample of the liquid medium comprises a controlled suctioning of the liquid medium into the confinement tube by means of a suctioning device.

14. The method for characterizing particles according to claim 10, wherein:
the confinement tube passes hermetically through a lateral wall of the measurement probe through two ends of the measurement probe; and
the step (a2) of introduction of the liquid medium sample comprises:
a rotation of the measurement probe into a first position so that the confinement tube is in a direction substantially parallel to a flow in the liquid medium, enabling the filling of the confinement tube; and
once the confinement tube is filled, the rotation of the measurement probe into a second position so that the confinement tube is in a direction substantially perpendicular to the flow in the liquid medium.

15. The method for characterizing particles according to claim 10, further comprising an adaptation of a focusing distance of the illumination beam in the sample as a function of a particle concentration of the liquid medium and/or of a particle absorption.
